(19) United States
(12) Patent Application Publication
(10) Pub. No.: US 2010/0293053 A1
(43) Pub. Date: Nov. 18, 2010

(54) PRICE-BASED DELAY OF AN ADVERTISEMENT

(75) Inventors: Venkat Sudhakar Potineni, San Jose, CA (US); Jedediah H. Paulson, San Mateo, CA (US); Sandeep K. Tukhar, Sunnyvale, CA (US); James A. Thordsen, Pleasanton, CA (US); Jane F. Lai, Los Altos Hills, CA (US); Ana L. Aspinall, Redwood City, CA (US); Katherine Ando, San Jose, CA (US); Oriana F. Behroozi, San Jose, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/465,518

(22) Filed: May 13, 2009

(51) Int. Cl. G06Q 30/00

(52) U.S. Cl. 705/14.53; 705/26

(57) ABSTRACT

A purchase record is accessed within a database of purchases. The purchase record includes a purchase date field and a purchase price field, respectively indicating a purchase date and a purchase price of a first item purchased from a seller by a purchaser. At a determination module located at a machine, a presentation delay interval is determined using the machine, the purchase date, and the purchase price. After expiration of the presentation delay interval, an advertisement is communicated to a device of the purchaser. The advertisement advertises a second item to replace the first item.

### TECHNICAL FIELD

The subject matter disclosed herein generally addresses methods and apparatus for presenting an advertisement, such as presenting a product offering to a potential buyer. Specifically, the present disclosure addresses such methods and apparatus where an advertisement of an item may be presented after a delay interval based on a purchase price of a previously purchased item.

### BACKGROUND

Systems for selling and marketing items and services (herein, collectively referred to as “items”) through use of a network (e.g., the Internet) are well-known. For example, some systems function as virtual storefronts, selling and marketing items to users accessing these systems via the network. While some sellers simultaneously operate both virtual and real-world storefronts (sometimes known as “brick-and-mortar” stores), other sellers may rely exclusively on virtual storefronts to sell and market items.

The marketing of items as replacements for previously purchased items is also well-known. Consumers are often provided with advertisements and various types of incentives, discounts, or other offers to replace a previously purchased item with a later version, a newer model, or a model with more features for improved functionality. For example, at a time near the end of applicable warranty periods, sellers of cars commonly contact their past customers by mail to advertise new cars. As another example, software frequently includes an automatic or manual feature to check whether a new version of the software is available, and if one is available, to advertise the new version to a user of the software.

### BRIEF DESCRIPTION OF THE DRAWINGS

Some embodiments are illustrated by way of example and not limitation in the figures of the accompanying drawings in which:

FIG. 1 illustrates an advertisement, according to some example embodiments, of an item to replace a previously purchased item;

FIG. 2 illustrates components of an apparatus, according to some example embodiments, of price-based advertisement delay;

FIG. 3 illustrates operations in a method, according to some example embodiments, of price-based advertisement delay; and

FIG. 4 illustrates components of an example machine able to read instructions from a machine-readable medium.

### DETAILED DESCRIPTION

Example methods and apparatus are directed to price-based delay of an advertisement. Examples merely typify possible variations. Unless explicitly stated otherwise, individual components and functions are optional and may be combined or subdivided. Unless explicitly stated otherwise, operations may be combined or subdivided, or vary in sequence. In the following description, for purposes of explanation, numerous specific details are set forth to provide a thorough understanding of example embodiments. It will be evident, however, to one skilled in the art that the present subject matter may be practiced without these specific details.

Generally, a purchaser of a particular item exhibits a reduced receptiveness to advertisements for a new item that replaces the particular item during a period of time following the purchase of the particular item. This period of reduced receptiveness is correlated with the purchase price of the particular item. An example of a potential benefit to price-based advertisement delay is a reduced likelihood of annoying the purchaser by advertising a replacement during the time period in which the purchaser is less receptive to such advertising.

A purchase record is accessed within a database of purchases. The purchase record includes a purchase date field and a purchase price field, respectively indicating a purchase date and a purchase price of a first item purchased from a seller by a purchaser. At a determination module at a machine, a presentation delay interval is determined using the machine, the purchase date, and the purchase price. After expiration of the presentation delay interval, an advertisement is communicated to a device of the purchaser. The advertisement advertises a second item to replace the first item.

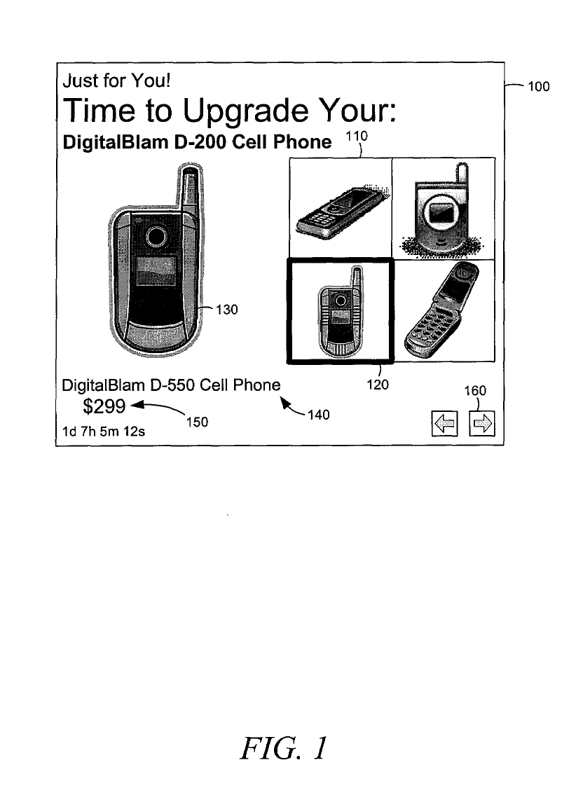

FIG. 1 illustrates an advertisement, according to some example embodiments, of a second item to replace a previously purchased first item. As used herein, “first item” refers to an item previously purchased from a seller by a purchaser, and “second item” refers to an item advertised to the purchaser as a replacement for the first item.

The advertisement is embodied in window 100, which displays text and images 110, 120, and 130. In the example shown, window 100 is a graphical user interface (GUI) window for displaying information in an electronic viewing screen (e.g., a computer monitor, or a cellphone display). In some example embodiments, window 100 may contain one or more interactive elements allowing a user to initiate a request for additional content. For example, window 100 or any portion of window 100 may be hyperlinked to further product information, advertising information, or purchasing information.

In the example shown, window 100 includes description 140 of the second item (e.g., “DigitalBlam D-550 Cell Phone”), which is advertised as a replacement for the first item (e.g., “DigitalBlam D-200 Cell Phone”). In some example embodiments, window 100 includes image 120 of the second item. In certain example embodiments, window 100 includes price 150 of the second item. In various example embodiments, window 100 includes a title of the second item (e.g., a short name or phrase) to identify the second item.

In some example embodiments, window 100 includes image 130 of the first item. In other example embodiments, image 130 is an image representing a general concept associated with the first item (e.g., a stock image, or a file photo). In further example embodiments, image 130 is omitted.

In the example shown, window 100 includes additional images (e.g., image 110) of additional items advertised as replacements for the first item. Image 120 may be highlighted or otherwise visually distinguished to indicate an association with description 140.

Window 100 includes one or more navigation controls (e.g., arrow button 160). In the example shown, arrow button 160 is a hyperlink that allows the purchaser to request display of one or more additional advertised items. For example, touching or clicking on arrow button 160 may cause currently displayed images (e.g., image 120) to be replaced with other images of other advertised items, as well as corresponding replacements of description 140 and price 150.

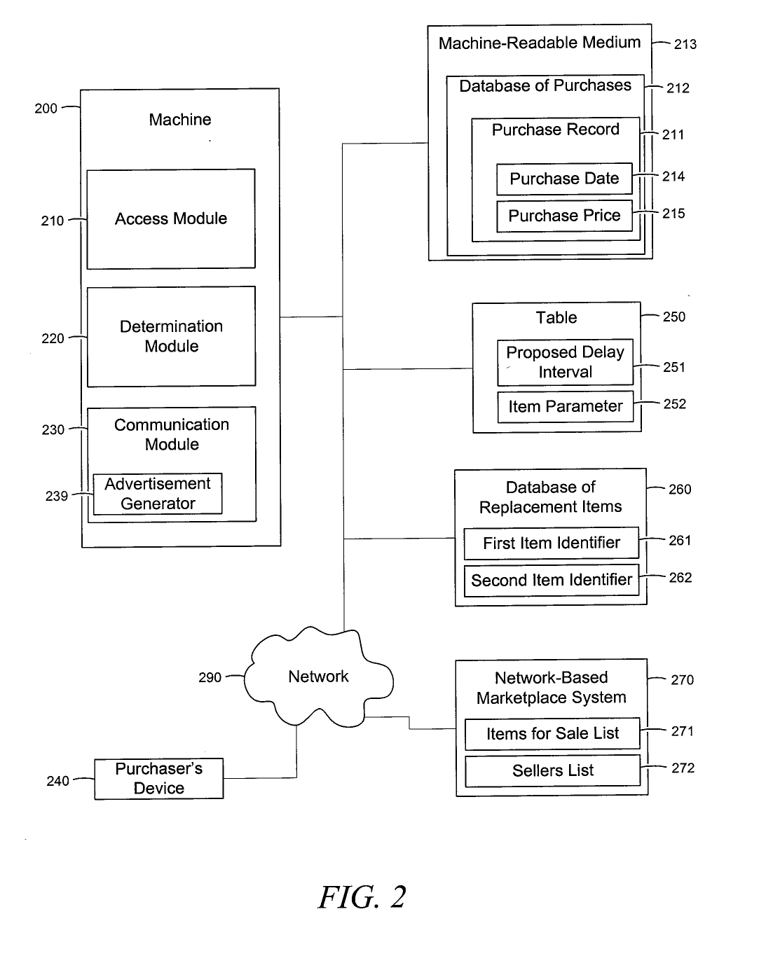

FIG. 2 illustrates components of an apparatus, according to some example embodiments, of price-based delay of an advertisement. The apparatus is embodied in machine 200, which in the example shown includes access module 210, determination module 220, and communication module 230.

Access module 210 is communicatively coupled to access machine-readable medium 213, which stores database of purchases 212. As used herein, “communicatively coupled” means configured to communicate information via one or more control structures and one or more data structures. Database of purchases 212 includes purchase record 211. Purchase record 211 includes purchase date field 214, which stores data that indicates a purchase date of the first item purchased from a seller by the purchaser, and purchase price field 215, which stores data that indicates a purchase price of the first item. Access module 210 accesses purchase record 211. For example, access module 210 accesses purchase record 211 by leaving the purchase date from purchase date field 214, and reading the purchase price from purchase price field 215.

Determination module 220 is communicatively coupled to access module 210. Determination module 220 uses the purchase date, the purchase price, and machine 200 to determine a presentation delay interval. The presentation delay interval is used to delay communicating an advertisement of the second item to the purchaser so as to reduce the likelihood of annoying the purchaser by encouraging replacement of the first item too early. For example, the presentation delay interval may be determined by using machine 200 to access table 250 and read proposed delay interval 251 associated with the purchase price. As another example, the presentation delay interval may be determined by using machine 200 to transmit the purchase data and the purchase price to network-based marketplace system 270 and receive the presentation delay interval in response. As a further example, the presentation delay interval may be determined by using machine 200 to calculate the presentation delay interval based on the purchase date and the purchase price.

Communication module 230 is communicatively coupled to access module 210 and determination module 220. After expiration of the presentation delay interval, communication module 230 communicates an advertisement (e.g., FIG. 1, window 100) to the purchaser at a device of the purchaser (e.g., purchaser's device 240). For example, communication module 230 may transmit the advertisement (e.g., FIG. 1, window 100) via network 290 to purchaser's device 240.

Purchaser's device 240 may be any device or machine of the purchaser able to receive an advertisement (e.g., FIG. 1, window 100) via a communication network using one or more communication protocols. For example, purchaser's device 240 may be a personal computer, a cellphone, a personal data assistant, a global positioning system device, a networked wristwatch, a smart phone, a television, a network appliance, a videogame console, or other communication-enabled device.

Network 290 may be any network able to communicate information constituting an advertisement (e.g., FIG. 1, window 100). Network 290 may include wired networks, wireless networks, and combinations thereof, as well as private networks, public networks, and combinations thereof (e.g., the Internet).

In some example embodiments, communication module 230 communicates an advertisement (e.g., FIG. 1, window 100) including one or more advertising elements. As used herein, “advertising elements” are text, image, audio, or video data related to advertising, merchandising, or promoting a sale of an item. Advertising elements include, but are not limited to, an item title, an item description (e.g., FIG. 1, description 140), an item price (e.g., FIG. 1, price 150), and an item image (e.g., FIG. 1, image 120).

In certain example embodiments, access module 210 accesses a table 250. Table 250 associates proposed delay interval 251 with item parameter 252. Item parameter 252 includes at least one of the following: a price, a price range, an item category, a geographical region, a first item identifier representative of the first item, a second item identifier representative of the second item, a seller identifier representative of the seller, or a purchaser identifier representative of the purchaser. In these example embodiments, determination module 220 determines the presentation delay interval using proposed delay interval 251 and item parameter 252.

In various example embodiments, access module 210 accesses database of replacement items 260. Database of replacement items 260 associates the first item with the second item by associating first item identifier 261 with second item identifier 262. In these example embodiments, purchase record 211 includes first item identifier 261, and determination module 220 identifies the second item based on the first item by using first item identifier 261.

In some example embodiments, access module 210 accesses network-based marketplace system 270. For example, access module 210 may read via network 290 information served by a virtual storefront. Network-based marketplace system 270 includes a list of items for sale (e.g. items for sale list 271) and a list of sellers of those items (e.g., sellers list 272). In these example embodiments, determination module 220 selects the second item from the list of items for sale (e.g., items for sale list 271). According to various example embodiments, network-based marketplace system 270 may be a networked-based auction system. In these example embodiments, determination module 220 selects the second item based on an auction end time corresponding to one of the listed items for sale. For example, where multiple sellers are auctioning multiple instances of the same item, determination module 220 may select as the second item the instance with the earliest auction end time (e.g., the next auction to close).

In certain example embodiments, access module 210 receives an indication that the second item is available for purchase or unavailable for purchase. For example, a seller of the second item may communicate to access module 210 an electronic message that includes inventory information with respect to the second item. Inventory information may be received in response to machine 200 polling a seller, polling a machine of the seller, or otherwise accessing an inventory database or other inventory manager to determine availability of the second item. According to some example embodiments, access module 210 receives an indication that the second item is available for purchase, and in response, determination module 220 shortens the presentation delay interval. According to other example embodiments, access module 210 receives an indication that the second item is unavailable for purchase, and in response, determination module 220 lengthens the presentation delay interval. According to further example embodiments, access module 210 receives more than one indication that the second item is available or unavailable, and determination module 220 responds to each indication by respectively shortening or lengthening the presentation delay interval.

In various example embodiments, access module 210 receives an indication that the second item is unavailable for purchase, and in response, communication module 230 lists the second item (e.g., by listing a second item identifier) on a watch list of the purchaser. As used herein, “watch list” refers to a list used by the purchaser for tracking one or more items with respect to availability for purchase. For example, in response to access module 210 receiving an indication that the second item is unavailable for purchase, communication module 230 may write a second item identifier to a database representative of the purchaser's holiday “wish list,” wedding registry, or other listing of desired items.

In some example embodiments, communication module 230 communicates an electronic message to purchaser's device 240 after expiration of the presentation delay interval. For example, after expiration of the presentation delay interval, communication module 230 may send an email message, a text message, an audio clip (e.g., a voice recording), a video clip, or other electronic communication. According to certain example embodiments, the electronic message includes the advertisement (e.g., FIG. 1, window 100). According to various example embodiments, the electronic message includes information notifying the purchaser that the advertisement (e.g., FIG. 1, window 100) is available at purchaser's device 240.

In certain example embodiments, after expiration of the presentation delay interval, communication module 230 communicates to purchaser's device 240 a proposal that the purchaser resell the first item (e.g., as a “trade-in” for the second item advertised by the advertisement). For example, after expiration of the presentation delay interval, communication module 230 may send an email message, a text message, an audio clip (e.g., a voice recording), a video clip, or other electronic communication proposing that the purchaser resell the first item. The proposal may be included in the advertisement (e.g., FIG. 1, window 100), a separate electronic message, or any combination thereof.

In various example embodiments, communication module 230 includes advertisement generator 239, which generates the advertisement (e.g., FIG. 1, window 100). For example, advertisement generator 239 may generate the advertisement (e.g., FIG. 1, window 100) by compiling one or more advertising elements. As noted above, advertising elements include, but are not limited to, an item title, an item description (e.g., FIG. 1, description 140), an item price (e.g., FIG. 1, price 150), and an item image (e.g., FIG. 1, image 120).

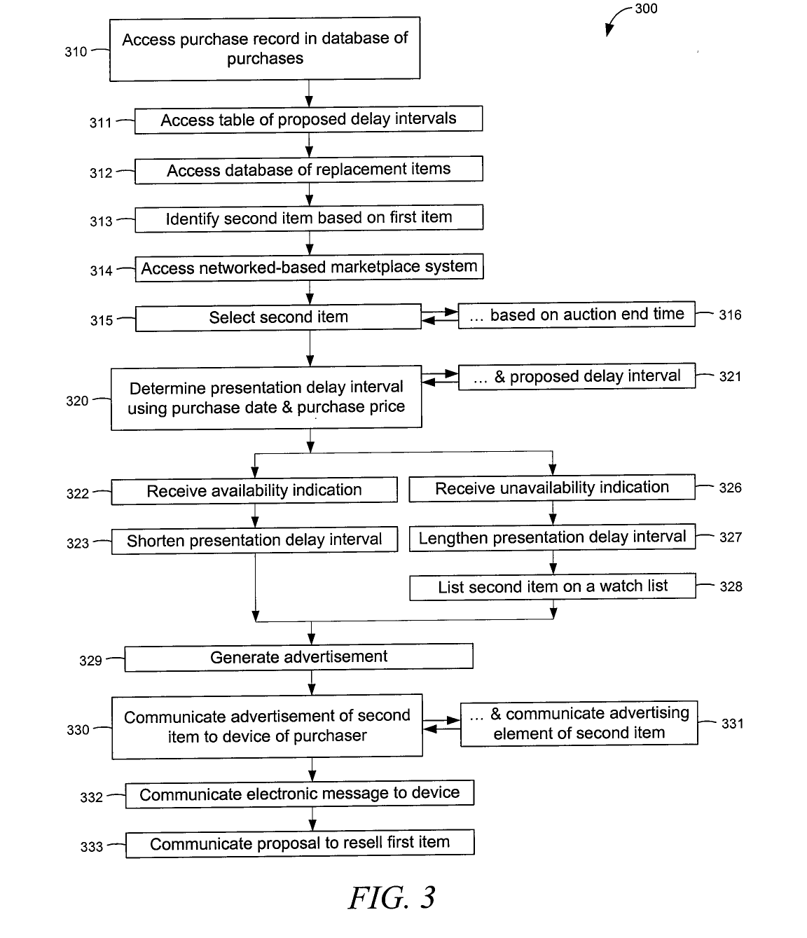

FIG. 3 illustrates operations in method 300, according to some example embodiments, of price-based delay of an advertisement.

Operation 310 involves accessing a purchase record (e.g., FIG. 2, purchase record 211) within a database of purchases (e.g., FIG. 2, database of purchases 212) stored on a machine-readable medium (e.g., FIG. 2, machine-readable medium 213). The purchase record (e.g., FIG. 2, purchase record 211) includes a purchase date field (e.g., FIG. 2, purchase date field 214) that indicates a purchase date of the first item, and a purchase price field (e.g., FIG. 2, purchase price field 215) that indicates a purchase price of the first item. For example, the purchase record (e.g., FIG. 2, purchase record 211) may be accessed by reading the purchase date from the purchase date field (e.g., FIG. 2, purchase date field 214) and reading the purchase price from the purchase price field (e.g., FIG. 2, purchase price field 215).

Operation 320 involves determining a presentation delay interval using the purchase date, the purchase price, and a determination module at a machine (e.g., FIG. 2, determination module 220 at machine 200). For example, the presentation delay interval may be determined by using the machine (e.g., FIG. 2, machine 200) to access a table (e.g., FIG. 2, table 250) and read a proposed delay interval (e.g., FIG. 2, proposed delay interval 251) associated with the purchase price. As another example, the presentation delay interval may be determined by using the machine (e.g., FIG. 2, machine 200) to transmit the purchase date and the purchase price to a network-based marketplace system (e.g., FIG. 2, network-based marketplace system 270) and receive the presentation delay interval in response. As a further example, the presentation delay interval may be determined by using the machine (e.g., FIG. 2, machine 200) to calculate the presentation delay interval based on the purchase date and the purchase price.

Operation 330 involves communicating an advertisement (e.g., FIG. 1, window 100) of a second item to a device of the purchaser (e.g., FIG. 2, purchaser's device 240) after expiration of the presentation delay interval. For example, the advertisement (e.g., FIG. 1, window 100) may be communicated by transmitting the advertisement (e.g., FIG. 1, window 100) via a network (e.g., FIG. 2, network 290) to the device of the purchaser (e.g., FIG. 2, purchaser's device 240).

In some example embodiments, operation 330 includes operation 331, which involves communicating the advertisement (e.g., FIG. 1, window 100) including one or more advertising elements. As noted above, advertising elements include, but are not limited to, an item title, an item description (e.g., FIG. 1, description 140), an item price (e.g., FIG. 1, price 150), and an item image (e.g., FIG. 1, image 120).

In certain example embodiments, method 300 includes operation 311, which involves accessing a table (e.g., FIG. 2, table 250) that associates a proposed delay interval (e.g., FIG. 2, proposed delay interval 251) with an item parameter (e.g., FIG. 2, item parameter 252). As noted above, the item parameter (e.g., FIG. 2, item parameter 252) may be, but is not limited to, a price, a price range, an item category, a geographical region, a first item identifier representative of the first item, a second item identifier representative of the second item, a seller identifier representative of the seller, or a purchaser identifier representative of the purchaser. In these example embodiments, operation 320 includes operation 321, which involves determining the presentation delay interval using the proposed delay interval (e.g., FIG. 2, proposed delay interval 251) and the item parameter (e.g., FIG. 2, item parameter 252).

In various example embodiments, method 300 includes operation 312, which involves accessing a database of replacement items (e.g., FIG. 2, database of replacement items 260) that associates the first item with the second item by associating a first item identifier (e.g., FIG. 2, first item identifier 261) with a second item identifier (e.g., FIG. 2, second item identifier 262). In these example embodiments, operation 310 involves accessing a purchase record (e.g., FIG. 2, purchase record 211) including the first item identifier (e.g., FIG. 2, first item identifier 261), and operation 320 includes operation 313, which involves identifying the second item based on the first item by using the first item identifier (e.g., FIG. 2, first item identifier 261).

In some example embodiments, method 300 includes operation 314, which involves accessing a network-based marketplace system (e.g., FIG. 2, network-based marketplace system 270) that includes a list of items for sale (e.g., FIG. 2, items for sale list 271) and a list of sellers of those items (e.g., FIG. 2, sellers list 272). For example, the network-based marketplace system (e.g., FIG. 2, network-based marketplace system 270) may be accessed by reading, through use of a network (e.g., FIG. 2, network 290), information served by a virtual storefront. In these example embodiments, method 300 includes operation 315, which involves selecting the second item from the list of items for sale (e.g., FIG. 2, items for sale list 271). According to various example embodiments, the network-based marketplace system (e.g., FIG. 2, network-based marketplace system 270) may be a network-based auction system. In these example embodiments, operation 315 includes operation 316, which involves selecting the second item based on an auction end time corresponding to one of the listed items for sale. For example, where multiple sellers are auctioning multiple instances of the same item, operation 316 may involve selecting as a second item the instance with the earliest auction end time (e.g., the next auction to close).

In certain example embodiments, method 300 includes operation 322, which involves receiving an indication that the second item is available for purchase. For example, an electronic message with information with respect to availability of the second item may be received from a seller of the second item. In these example embodiments, method 300 may include operation 323, which involves shortening the presentation delay interval in response to receiving the indication that the second item is available for purchase. For example, the presentation delay interval may be shortened to expire immediately.

In certain example embodiments, method 300 includes operation 326, which involves receiving an indication that the second item is unavailable for purchase. For example, an electronic message with information with respect to unavailability of the second item may be received from a seller of the second item. In some of these example embodiments, method 300 may include operation 327, which involves lengthening the presentation delay interval in response to receiving an indication that the second item is unavailable for purchase. For example, the presentation delay interval may be lengthened by a day, week, a month, a quarter, year, or other period of time. In some of these example embodiments, method 300 may include operation 328, which involves listing the second item on a watch list of the purchaser. For example, the second item may be listed by writing a second item identifier (e.g., FIG. 2, second item identifier 262) to a purchaser's holiday “wish list,” wedding registry, or other listing of desired items.

In example embodiments that include operation 322, operation 326, or both, either operation or both operations may be performed more than once, and operations 323, 327, or 328 may be performed more than once in response to each received indication.

In some example embodiments, method 300 includes operation 332, which involves communicating an electronic message to a device of the purchaser (e.g., FIG. 2, purchaser's device 240) after expiration of the presentation delay interval. For example, after expiration of the presentation delay interval, an email message may be sent to the device of the purchaser (e.g., FIG. 2, purchaser's device 240). Additional examples of electronic messages include, but are not limited to, a text message, an audio clip (e.g., voice recording), a video clip, or other electronic communication. According to various example embodiments, the electronic message includes the advertisement (e.g., FIG. 1, window 100). According to various example embodiments, the electronic message includes information notifying the purchaser that the advertisement (e.g., FIG. 1, window 100) is available at the device of the purchaser (e.g., FIG. 2, purchaser's device 240).

In certain example embodiments, method 300 includes operation 333, which involves communicating to a device of the purchaser (e.g., FIG. 2, purchaser's device 240) a proposal that the purchaser resell the first item (e.g., as a “trade-in” for the second item advertised by the advertisement). For example, after expiration of the presentation delay interval, an email message or other electronic communication may be sent proposing that the purchaser resell the first item. The proposal may be included in the advertisement (e.g., FIG. 1, window 100), a separate communication, or any combination thereof.

In various example embodiments, method 300 includes operation 329, which involves generating the advertisement (e.g., FIG. 1, window 100). For example, the advertisement (e.g., FIG. 1, window 100) may be generated by compiling one or more advertising elements. As noted above, advertising elements include, but are not limited to, an item title, an item description (e.g., FIG. 1, description 140), an item price (e.g., FIG. 1, price 150) and an item image (e.g., FIG. 1, image 120).

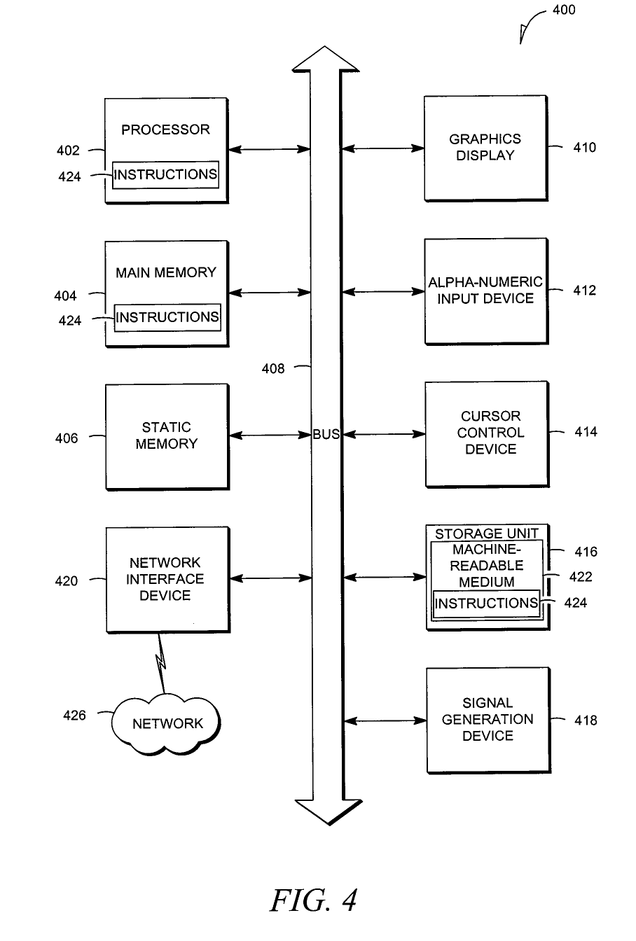

FIG. 4 illustrates components of an example machine able to read instructions from a machine-readable medium. Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include a collection of machines that individually or jointly execute instructions 424 to perform any one or more of the methodologies discussed herein.

Computer system 400 includes processor 402 (e.g., a central processing unit (CPU), a graphics processing unit (GPU), a digital signal processor (DSP), application specific integrated circuits (ASICs), radio-frequency integrated circuits (RFICs), or any combination of these), main memory 404, and static memory 406, which communicate with each other via bus 408. Computer system 400 may further include graphics display unit 410 (e.g., a plasma display panel (PDP), a liquid crystal display (LCD), a projector, or a cathode ray tube (CRT)). Computer system 400 may also include alphanumeric input device 412 (e.g., a keyboard), cursor control device 414 (e.g., a mouse, a trackball, a joystick, a motion sensor, or other pointing instrument), storage unit 416, signal generation device 418 (e.g., a speaker), and network interface device 420.

Storage unit 416 includes a machine-readable medium 422 on which is stored instructions 424 (e.g., software) embodying any one or more of the methodologies or functions described herein. Instructions 424 (e.g., software) may also reside, completely or at least partially, within main memory 404 and/or within processor 402 (e.g., within a processor's cache memory) during execution thereof by computer system 400, main memory 404 and processor 402 also constituting machine-readable media. Instructions 424 (e.g., software) may be transmitted or received over network 426 via network interface device 420.

While machine-readable medium 422 is shown in an example embodiment to be a single medium, the term “machine-readable medium” should be taken to include a single medium or multiple media (e.g., a centralized or distributed database, and/or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies of the present subject matter. The term “machine-readable medium” shall accordingly be taken to include, but not be limited to, data repositories in the form of solid-state memories, optical media, and magnetic media.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain systems, apparatus or processes are described herein as being implemented in or through use of one or more “modules.” A “module,” as used herein, is an apparatus configured to perform identified functionality through software, firmware, hardware, or any combination thereof. When the functionality of a module is performed in any part through software or firmware, the module includes at least one machine-readable medium bearing instructions which, when executed by one or more processors, perform that portion of the functionality implemented in software or firmware. The modules may be regarded as being communicatively coupled to one another to at least the degree needed to implement the described functionalities.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. The one or more processors or processor-implemented modules may also operate to support performance of the relevant operations in a “cloud computing” environment or “software as a service” (SaaS) environment. For example, at least some of the operations may be performed by a group of computers (as examples of machines including processors), these operations being accessible via a network (e.g., the Internet) and via one or more appropriate interfaces (e.g., an application program interface (API)).

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive or, unless specifically stated otherwise.

What is claimed is:

1. An apparatus comprising:
an access module configured to access a purchase record within a database of purchases, the database stored on a machine-readable medium, the purchase record including:
a purchase date field indicative of a purchase date of a first item purchased from a seller by a purchaser, and
a purchase price field indicative of a purchase price of the first item;
a determination module implemented at least in part by a processor of a machine, the determination module configured to determine a presentation delay interval using the purchase date and using the purchase price; and
a communication module configured to communicate an advertisement of a second item to a device of the purchaser after expiration of the presentation delay interval, the second item to replace the first item.

2. The apparatus of claim 1, wherein the communication module is configured to communicate an advertising element of the second item, and wherein the advertising element is selected from the group consisting of an item title, an item description, an item price, and an item image.

3. The apparatus of claim 1, wherein the determination module is configured to determine the presentation delay interval using a proposed delay interval and an item parameter; and wherein the access module is configured to access a table associating the proposed delay interval with the item parameter selected from the group consisting of a price, a price range, an item category, a geographical region, a first item identifier representative of the first item, a second item identifier representative of the second item, a seller identifier representative of the seller, and a purchaser identifier representative of the purchaser.

4. The apparatus of claim 1, wherein the database of purchases is a first database; wherein the access module is configured to access a second database of replacement items, wherein the second database associates the first item with the second item; and wherein the determination module is configured to identify the second item based on the first item.

5. The apparatus of claim 1, wherein the access module is configured to access a network-based marketplace system listing a plurality of items for sale by a plurality of sellers, wherein the second item is one of the plurality of items for sale; and wherein the determination module is configured to select the second item.

6. The apparatus of claim 5, wherein the network-based marketplace system is a network-based auction system; and wherein the selection of the second item is based on an auction end time corresponding to one of the plurality of items for sale.

7. The apparatus of claim 1, wherein the access module is configured to receive an indication that the second item is available for purchase; and wherein the determination module is configured to shorten the presentation delay interval in response to the receiving of the indication.

8. The apparatus of claim 1, wherein the access module is configured to receive an indication that the second item is unavailable for purchase; and wherein the determination module is configured to lengthen the presentation delay interval in response to the receiving of the indication.

9. The apparatus of claim 1, wherein the access module is configured to receive an indication that the second item is unavailable for purchase; and wherein the communication module is configured to list the second item on a watch list of the purchaser in response to the receiving of the indication.

10. The apparatus of claim 1, wherein the communication module is configured to communicate an electronic message to the device of the purchaser after expiration of the presentation delay interval.

11. The apparatus of claim 1, wherein the communication module is configured to communicate a proposal to the device of the purchaser after expiration of the presentation delay interval, and wherein the proposal proposes a resale of the first item by the purchaser.

12. The apparatus of claim 1, wherein the communication module includes an advertisement generator configured to generate the advertisement.

13. A method comprising the acts of:
accessing a purchase record within a database of purchases, the database stored on a machine-readable medium, the purchase record including:
a purchase date field indicative of a purchase date of a first item purchased from a seller by a purchaser, and
a purchase price field indicative of a purchase price of the first item;
determining a presentation delay interval through use of a determination module implemented at least in part by a processor of a machine, the act of determining using the purchase date and using the purchase price; and
communicating an advertisement of a second item to a device of the purchaser after expiration of the presentation delay interval, the second item to replace the first item.

14. The method of claim 13, wherein the act of communicating the advertisement includes the act of communicating an advertising element of the second item, and wherein the advertising element is selected from the group consisting of an item title, an item description, an item price, and an item image.

15. The method of claim 13, wherein the act of determining of the presentation delay interval includes using a proposed delay interval and an item parameter, the method further comprising the act of:
accessing a table associating the proposed delay interval with the item parameter selected from the group consisting of a price, a price range, an item category, a geographical region, a first item identifier representative of the first item, a second item identifier representative of the second item, a seller identifier representative of the seller, and a purchaser identifier representative of the purchaser.

16. The method of claim 13, wherein the database of purchases is a first database, the method further comprising the acts of:
accessing a second database of replacement items, the second database associating the first item with the second item; and
identifying the second item based on the first item.

17. The method of claim 13 further comprising the acts of:
accessing a network-based marketplace system listing a plurality of items for sale by a plurality of sellers, the second item being one of the plurality of items for sale; and
selecting the second item.

18. The method of claim 17, wherein the network-based marketplace system is a network-based auction system, and wherein the act of selecting of the second item is based on an auction end time corresponding to one of the plurality of items for sale.

19. The method of claim 13 further comprising the acts of:
receiving an indication that the second item is available for purchase; and
shortening the presentation delay interval in response to the receiving of the indication.

20. The method of claim 13 further comprising the acts of:
receiving an indication that the second item is unavailable for purchase; and
lengthening the presentation delay interval in response to the receiving of the indication.

21. The method of claim 13 further comprising the acts of:
receiving an indication that the second item is unavailable for purchase; and
listing the second item on a watch list of the purchaser.

22. The method of claim 13 further comprising the act of:
communicating an electronic message to the device of the purchaser after expiration of the presentation delay interval.

23. The method of claim 13 further comprising the act of:
communicating a proposal to the device of the purchaser after expiration of the presentation delay interval, the proposal proposing a resale of the first item by the purchaser.

24. The method of claim 13 further comprising the act of:
generating the advertisement.

25. A machine-readable storage medium comprising a set of instructions that, when executed by one or more processors of a machine, cause the machine to:
access a purchase record within a database of purchases, the purchase record including:
a purchase date field indicative of a purchase date of a first item purchased from a seller by a purchaser, and
a purchase price field indicative of a purchase price of the first item;
determine a presentation delay interval using a determination module implemented by a processor at the machine, the determining of the presentation delay interval using the purchase date and the purchase price; and
communicate an advertisement of a second item to a device of the purchaser after expiration of the presentation delay interval, the second item to replace the first item.

26. A system comprising:
means for accessing a purchase record within a database of purchases, the database stored on a machine-readable medium, the purchase record including:
a purchase date field indicative of a purchase date of a first item purchased from a seller by a purchaser, and
a purchase price field indicative of a purchase price of the first item;
means for determining a presentation delay interval using a determination module implemented by a processor at a machine, the determining of the presentation delay interval using the purchase date and the purchase price; and
means for communicating an advertisement of a second item to a device of the purchaser after expiration of the presentation delay interval, the second item to replace the first item.
